(19) United States
(12) Patent Application Publication
(10) Pub. No.: US 2015/0053008 A1
(43) Pub. Date: Feb. 26, 2015

(54) TORQUE DETECTION DEVICE

(71) Applicant: PANASONIC INTELLECTUAL PROPERTY MANAGEMENT CO., LTD., Osaka (JP)

(72) Inventor: Noriyuki JITOUSHO, Osaka (JP)

(21) Appl. No.: 14/531,971

(22) Filed: Nov. 3, 2014

Related U.S. Application Data
(63) Continuation of application No. PCT/JP2013/003355, filed on May 28, 2013.

(30) Foreign Application Priority Data
May 31, 2012 (JP) 2012-124097

(51) Int. Cl. G01H 1/00; G01L 5/00; G01H 11/00; G01H 1/04

(52) U.S. Cl. CPC G01H 1/003; G01H 1/04; G01L 5/0042; G01H 11/00
USPC 73/581

(57) ABSTRACT

A torque detection device that detects a torque of a rotating body installed on an object unit, and comprises a distortion detector unit attached to the rotating body, an oscillation circuit disposed on the object unit, and a detection circuit disposed on the object unit and for converting a signal output from the distortion detector unit into a torque signal. The electro-magnetic coupler couples the distortion detector unit with the oscillation circuit electrically, and the electro-magnetic coupler couples the distortion detector unit with the detection circuit electrically. This structure can achieve downsizing of the torque detection device of high detecting accuracy.

This is a continuation of International Application No. PCT/JP2013/003355, with an international filing date of May 28, 2013, which claims priority of Japanese Patent Application No. 2012-124097, filed on May 31, 2012, the contents of each of which are hereby incorporated by reference.

### BACKGROUND

1. Technical Field

The present disclosure relates to a torque detection device for detecting a magnitude of torque exerted on a rotating body.

2. Description of the Related Art

A conventional method generally known for detecting a torque of a rotating body is described as follows. First, a distortion sensor element attached to the rotating body is vibrated at a predetermined frequency, and a torque is applied to the rotating body. Next, when the torque is applied to the rotating body, the distortion sensor element deforms. The torque on the rotating body is subsequently detected by reading a change in the vibrating frequency that occurs when the distortion sensor element deforms, and converting the change into a torque value.

Patent literature 1, for example, is known as one document of the conventional art information.

### CITATION LIST

### Patent Literature

Patent literature 1: Unexamined Japanese Patent Publication No. 2011-164042

### SUMMARY

A drive circuit for vibrating a distortion sensor element at a predetermined frequency and a detection circuit for converting a signal output from the distortion sensor element into a torque information signal are disposed on an object unit to which a rotating body is installed. It is conceivable in this case that mechanical contact means such as a slip ring is used to make electrical connection between the drive circuit and the detection circuit disposed on the object unit and the distortion sensor element attached to the rotating body. When mechanical contact means is used for the electrical connection, however, variations occur in a contact resistance of the mechanical contact means due to wear, deformation and the like reasons, thereby giving rise to a problem that a detecting accuracy of the torque detection device changes.

It is also conceivable to use electro-magnetic coupling means such as coupling coils that do not require any mechanical contact, as an alternative to the mechanical contact means. In this case, it is possible that those parts, which require electric connections such as coupling between the drive circuit and the distortion sensor element and connection between the detection circuit and a distortion detection circuit, are coupled individually by using electro-magnetic coupling means. There exists a problem, however, that the torque detection device becomes large in size when the electro-magnetic coupling means are provided individually.

The present disclosure is therefore intended to provide a torque detection device of high detection accuracy with a small size.

To this end, one mode provided in the present disclosure is a torque detection device for detecting a torque of a rotating body installed on an object unit, and that the torque detection device comprises a distortion detector unit attached to the rotating body, an oscillation circuit disposed on the object unit, and a detection circuit disposed on the object unit and for converting a signal output from the distortion detector unit into a torque signal. An electro-magnetic coupler couples the distortion detector unit with the oscillation circuit electrically, and the same electro-magnetic coupler electrical couples the distortion detector unit with the detection circuit electrically.

With the above structure, the present disclosure can achieve downsizing of the torque detection device while keeping high detecting accuracy.

### BRIEF DESCRIPTION OF DRAWINGS

FIG. 1 is a circuit block diagram of a torque detection device according to one exemplary embodiment of the present disclosure.

FIG. 2 is a front view of a sensor element that constitutes a part of the torque detection device shown in FIG. 1.

FIG. 3 is a graphic representation showing changes in vibrating frequencies of beam portions versus distortion of the sensor element.

FIG. 4A is an illustration showing transition of a signal waveform in the torque detection device according to this exemplary embodiment.

FIG. 4B is an illustration showing transition of another signal waveform in the torque detection device according to this exemplary embodiment.

FIG. 4C is an illustration showing transition of another signal waveform in the torque detection device according to this exemplary embodiment.

FIG. 4D is an illustration showing transition of another signal waveform in the torque detection device according to this exemplary embodiment.

FIG. 4E is an illustration showing transition of still another signal waveform in the torque detection device according to this exemplary embodiment.

FIG. 4F is an illustration showing transition of yet another signal waveform in the torque detection device according to this exemplary embodiment.

FIG. 5 is a schematic drawing showing a motor-assisted bicycle equipped with the torque detection device according to this exemplary embodiment.

FIG. 6 is a schematic drawing showing a sprocket portion of the motor-assisted bicycle shown in FIG. 5.

### DETAILED DESCRIPTION OF THE PREFERRED EMBODIMENT

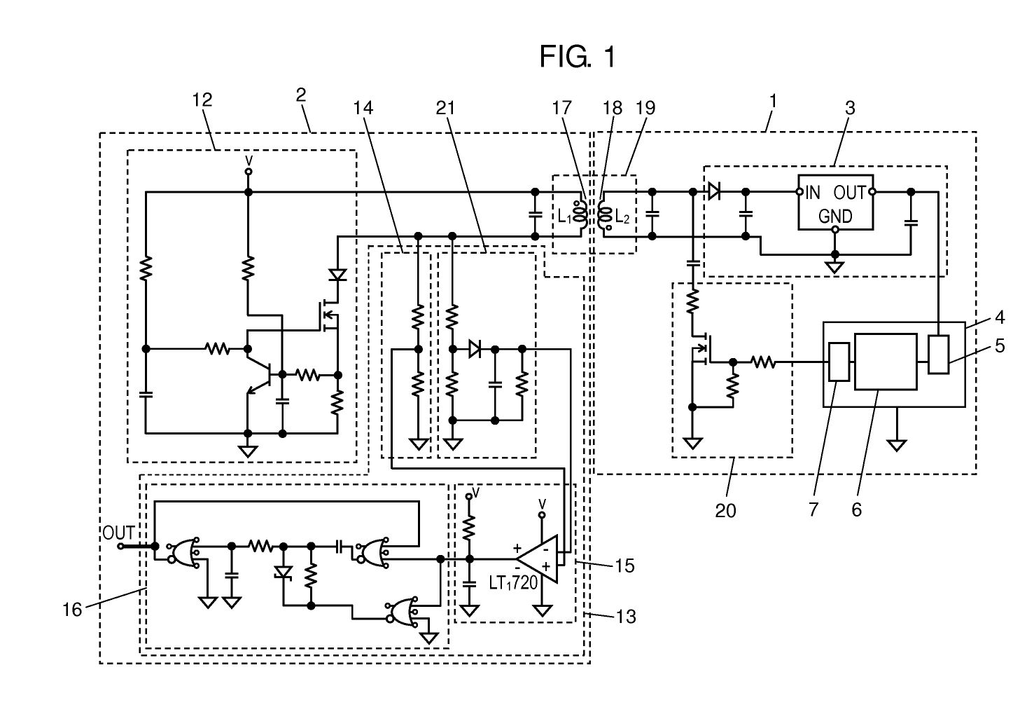

Referring to FIG. 1, description is provided hereinafter of a torque detection device according to one exemplary embodiment of the present disclosure.

FIG. 1 is a circuit block diagram of the torque detection device according to this embodiment of the disclosure. The torque detection device detects a torque of a rotating body (not shown) installed on an object unit (not shown). The torque detection device comprises distortion detector unit 1 installed on the rotating body, and control circuit 2 disposed on the object unit.

First, description is provided of a structure of distortion detector unit 1.

Distortion detector unit 1 comprises power supply circuit 3, sensor unit 4, switching circuit 20 and second coil 18. Power supply circuit 3 supplies electric power to sensor unit 4. Sensor unit 4 includes drive controller 5 for generating a driving signal, sensor element 6, and differential circuit 7. The driving signal generated and output from drive controller 5 vibrates sensor element 6 at a predetermined frequency. A detection signal output from sensor element 6 is subjected to a differential process in differential circuit 7.

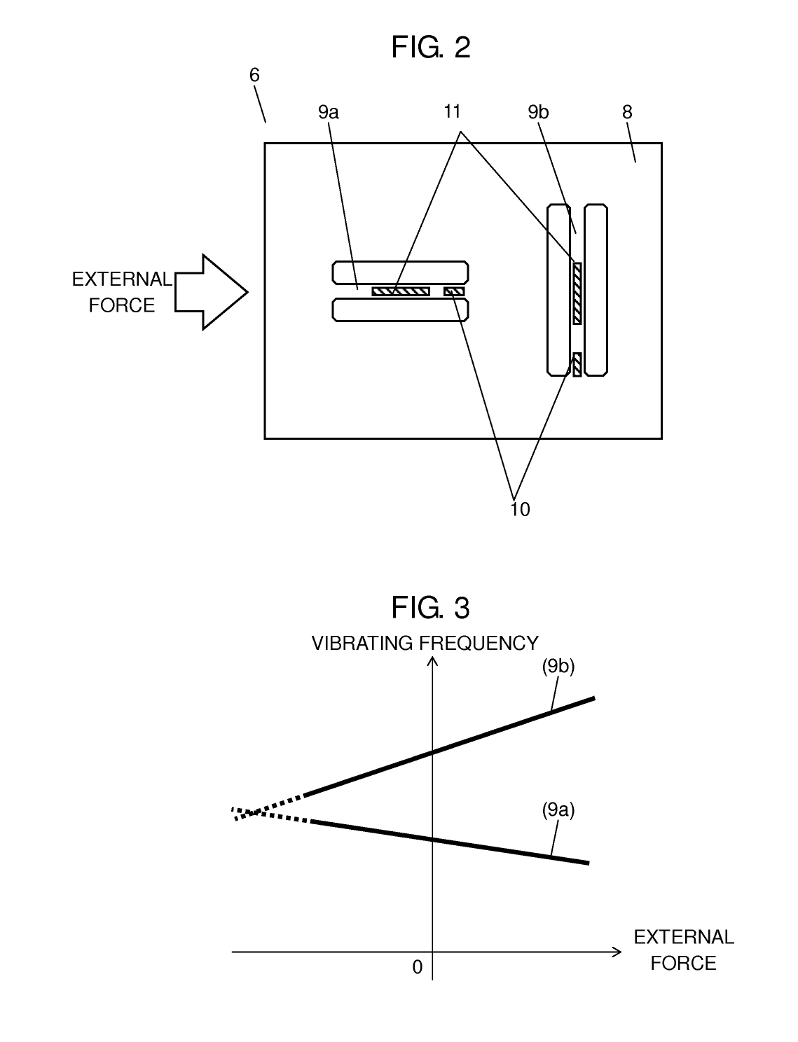

Referring to FIG. 2, description is provided next of a structure of sensor element 6.

As shown in FIG. 2, sensor element 6 is provided with beams 9a and 9b in a center portion of silicon substrate 8 having a rectangular shape. Beams 9a and 9b extend in a horizontal direction and a vertical direction respectively in the drawing.

Each of beams 9a and 9b has driving electrode 10 that expands and contracts according to the driving signal output from power supply circuit 3, and detecting electrode 11 that generates a detection signal responsive to vibration of corresponding one of beams 9a and 9b.

Driving electrode 10 and detecting electrode 11 are formed of, for example, a laminated structure having a lead-zirconate-titanate (“PZT”) piezoelectric layer sandwiched between a Pt electrode and an Au electrode. When used as driving electrodes 10, for instance, these electrodes are expanded and contracted according to the frequency of the driving signal to vibrate beams 9a and 9b, and when used as detecting electrodes 11, they induce detection signals corresponding to the vibrations of beams 9a and 9b.

In other words, beams 9a and 9b are preliminarily kept vibrated by the driving signal of the predetermined frequency with sensor element 6 attached to a rotating body. When a torque is exerted on the rotating body, a distortion occurs in the rotating body. The distortion that occurs in the rotating body causes sensor element 6 to distort, and a vibrating frequency of the detection signal output from each of detecting electrodes 11 change due to the distortion of sensor element 6.

To describe more specifically, when an external force is applied to sensor element 6 from a lateral side shown by an arrow (i.e., the left side in the drawing), a compressive stress acts upon beam 9a of which an extended direction is in line with a direction of the distortion. As a result, the vibrating frequency of beam 9a decreases in response to the external force, as shown by a solid line in FIG. 3. On the other hand, a tensile stress acts upon beam 9b of which an extended direction is orthogonal to the direction of the distortion, and the vibrating frequency of beam 9b increases in response to the external force, as shown by another solid line in FIG. 3. Accordingly, differential circuit 7 can efficiently produce an output of frequency change corresponding to the torque by making a differential operation of the detection signals output from individual detecting electrodes 11.

Next, description is provided of a structure of control circuit 2 with reference to FIG. 1.

Control circuit 2 disposed on the object unit comprises oscillation circuit 12 that generates the driving signal for power supply circuit 3, and detection circuit 13 that receives a signal output from distortion detector unit 1 and produces a predetermined torque signal. Detection circuit 13 includes first voltage-dividing circuit 14, binary circuit 15 and waveform-shaping circuit 16. First voltage-dividing circuit 14 converts the detection signal output from the detector unit into a predetermined voltage. Binary circuit 15 binarizes a divided voltage signal output from first voltage-dividing circuit 14 by comparing it with a reference voltage. Waveform-shaping circuit 16 shapes waveform of an output signal from binary circuit 15, and turns into a torque signal of a predetermined output form.

Description is provided next of switching circuit 20 that is configured within distortion detector unit 1.

Switching circuit 20 is provided to make a process of the detection signal transferred from sensor element 6 to detection circuit 13 separately from an oscillation signal transferred from oscillation circuit 12 to power supply circuit 3. Switching circuit 20 generates an inducing voltage for second coil 18 by using the signal output from sensor element 6. A pulsating wave is thus formed across second coil 18.

Next, description is provided of first voltage-dividing circuit 14 and second voltage-dividing circuit 21.

First voltage-dividing circuit 14 and second voltage-dividing circuit 21 are connected in parallel to each other. A pulsating wave induced in second coil 18 is converted into a predetermined voltage by second voltage-dividing circuit 21. After the conversion of the pulsating wave, the converted signal is rectified and smoothed for use as a reference voltage of binary circuit 15. Since both of the reference voltage and the first divided voltage are affected equally by any change in the output attributable to temperature changes and external perturbations, the above configuration can reduce an adverse influence upon a comparison value. Accordingly, detection circuit 13 of this embodiment has a structure configured to improve the accuracy of detection.

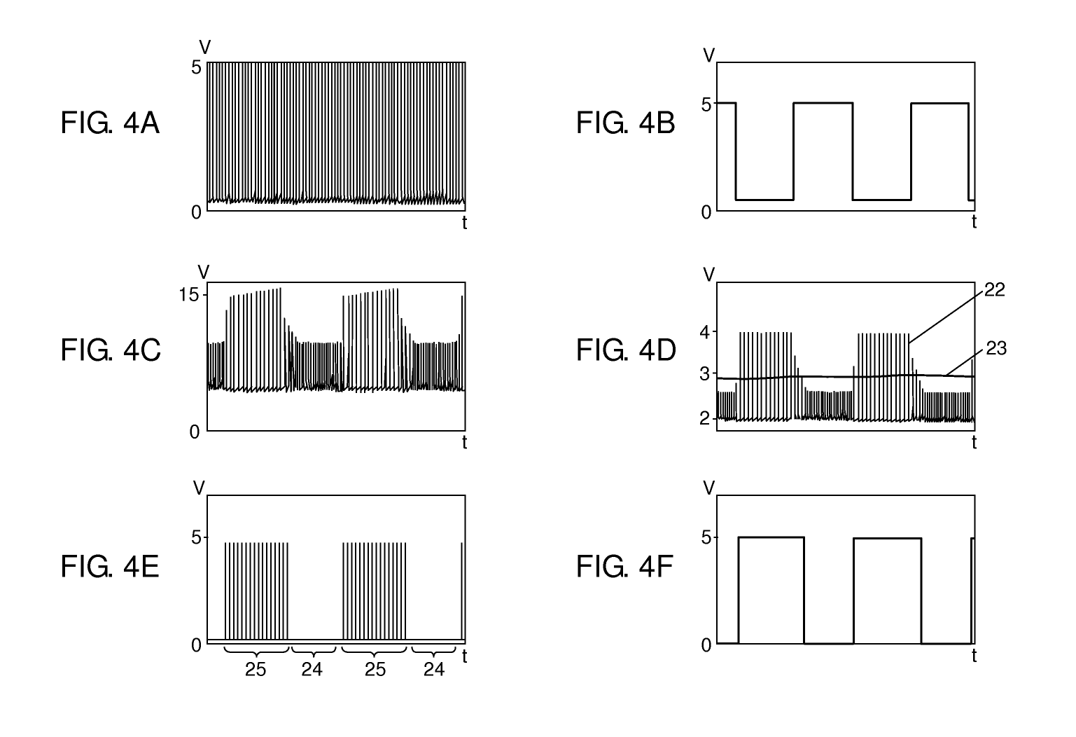

Referring to FIG. 4A to FIG. 4F, description is provided next about transition of signal waveforms in the torque detection device of this embodiment as described with reference to FIG. 1.

In the first place, an oscillation signal of about 150 kHz, shown in FIG. 4A, is generated by oscillation circuit 12. Next, this oscillation signal is induced across second coil 18 of electro-magnetic coupler 19, and the oscillation signal is converted by power supply circuit 3 into a supply voltage of 5V. This 5V supply voltage is supplied to drive controller 5. The supply voltage supplied to drive controller 5 vibrates sensor element 6. As a result, a driving signal is generated. The generated driving signal is output to differential circuit 7 though driving electrodes 10 (shown in FIG. 2). Subsequently, differential circuit 7 generates and outputs a differential signal.

FIG. 4B shows the differential signal output from differential circuit 7.

Since the differential signal shown in FIG. 4B is a signal of 5 kHz, it is difficult to couple this differential signal with electro-magnetic coupler 19. For this reason, the differential signal is subjected to switching operation of switching circuit 20 to produce a signal of pulsating waveform having about 15V and 150 kHz shown in FIG. 4C. This signal of pulsating waveform is coupled to first coil 17 through second coil 18. The signal of pulsating waveform induced across first coil 17 is converted by first voltage-dividing circuit 14 into a signal of about 4V, as shown by solid line 22 in FIG. 4D. At the same time, the signal of pulsating waveform induced across first coil 17 is voltage-converted by second voltage-dividing circuit 21 into a predetermined voltage. The voltage-converted signal of pulsating waveform is rectified and smoothed by second voltage-dividing circuit 21, and a reference voltage of about 3V (i.e., reference signal) shown by solid line 23 in FIG. 4D is produced.

The signal generated by first voltage-dividing circuit 14 and the reference signal generated by second voltage-dividing circuit 21 are input to binary circuit 15, in which these signals are converted into a binary signal shown in FIG. 4E.

Here, the process of converting into the binary signal is a process of bringing the detection signal of increased frequency back to a frequency level of about 5 kHz of the differential signal output from differential circuit 7 in order to achieve electro-magnetic coupling between first coil 17 and second coil 18. This creates a pulse wave shown in FIG. 4E that consists of L-level portions 24 and H-level portions 25 tuned to a frequency of the pulsating waveform. This continuous pulse waveform of H-level portions 25 is converted into a waveform of H-level voltage by waveform-shaping circuit 16. Thus shaped is a differential signal output from the differential circuit, that is, a torque signal of pulse waveform having the same frequency as the signal output from sensor unit 4, as shown in FIG. 4F. When a monostable multivibrator is used for the signal processing in waveform-shaping circuit 16, it can shape the waveform efficiently since it holds individual pulse waves of H-level portion 25 at their peak values for a predetermined period of time and converts them into a waveform of continuous peak values of H-level portion 25.

In the torque detection device of this embodiment, an electrical coupling of distortion detector unit 1 and control circuit 2 is achieved with electro-magnetic coupler 19 consisting of first coil 17 provided in control circuit 2 and second coil 18 provided in distortion detector unit 1, as is clear from the above description.

In other words, the electrical coupling between distortion detector unit 1 and control circuit 2 is made with electro-magnetic coupler 19. This structure avoids any change in contact resistance attributable to wear and deformation of mechanical contact means if used, and it can hence prevent degradation of detecting accuracy of the torque detection device for the prolonged use.

Moreover, this structure uses a single unit of electro-magnetic coupler 19 to make two electrical couplings, one between power supply circuit 3 and oscillation circuit 12, and the other between sensor unit 4 and detection circuits 13. This can make shared use of electro-magnetic coupler 19 necessary for the electro-magnetic coupling, and help reduce a size of the torque detection device. In other words, the torque detection device of this embodiment shares the same electro-magnetic coupler 19 to make the electrical coupling between power supply circuit 3 and oscillation circuit 12, and also the electrical coupling between sensor unit 4 and detection circuits 13, thereby achieving downsizing as well as high accuracy.

At the end, description is provided of an example of using the torque detection device of this embodiment.

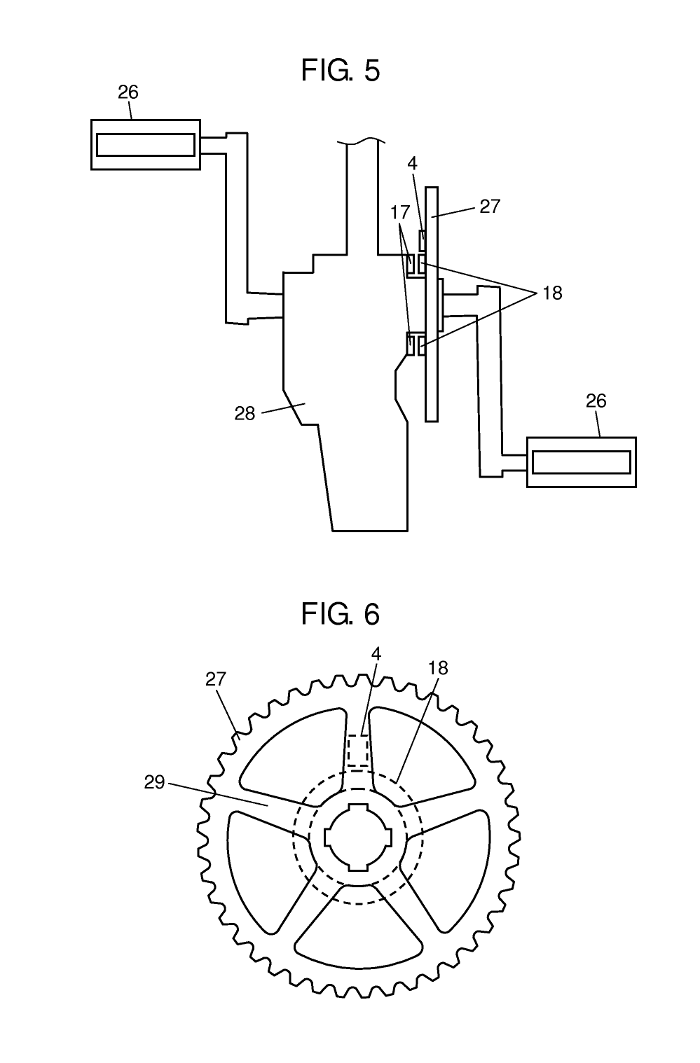

In the example shown in FIG. 5, the torque detection device of this embodiment is used for determining an amount of power to be assisted by auxiliary power unit 28 installed on a main body of a motor-assisted bicycle, by detecting a torque exerted on sprocket 27 when pedals 26 of the bicycle are rotated. In this case, sensor unit 4 is disposed on a face of one of beams 29 of sprocket 27, i.e. a rotating body, and second coil 18 is disposed around a rotary shaft, as shown in FIG. 6. In addition, control circuit 2 including first coil 17 is disposed on the main unit side of the bicycle as shown in FIG. 5, so that this structure can provide similar effects and advantages as those described in the above embodiment. Furthermore, since distortion detector unit 1 and control circuit 2 are disposed separately to their respective positions on the main body and the rotating body, they can be provided with measures against dust and water by hermetically sealing them individually with resin covers or the like members.

The present disclosure pertains to a torque detection device for detecting a torque of a rotating body installed on an object unit, and has an advantage of downsizing the torque detection device of high detecting accuracy.

In addition, the torque detection device of the present disclosure is useful for such applications as motor-assisted bicycles for which reduction in both size and weight is desired.

What is claimed is:

1. A torque detection device for detecting a torque of a rotating body installed on an object unit, the torque detection device comprising:
a distortion detector unit disposed on the rotating body;
an oscillation circuit disposed on the object unit; and
a detection circuit disposed on the object unit, and converting a signal output from the distortion detector unit into a torque signal, wherein
an electro-magnetic coupler couples the distortion detector unit with the oscillation circuit electrically, and
the electro-magnetic coupler couples the distortion detector unit with the detection circuit electrically.

2. The torque detection device of claim 1, wherein the electro-magnetic coupler includes a first coil and a second coil.

3. The torque detection device of claim 2, wherein
the distortion detector unit comprises:
a sensor unit including a frequency output type of sensor element;
a power supply circuit that receives an oscillation signal supplied from the oscillation circuit, and generates a driving signal for driving the sensor element; and
a switching circuit,
wherein
the first coil is connected with the oscillation circuit and the detection circuit,
the second coil is connected with the power supply circuit and the sensor unit, and
the switching circuit produces an inducing voltage for the second coil by using an output signal from the sensor element.

4. The torque detection device of claim 3, wherein the detection circuit includes:
a binary circuit;
a waveform-shaping circuit for shaping waveform of a binary signal output from the binary circuit;
a first voltage-dividing circuit that converts a pulsating wave induced in the first coil in response to the inducing voltage supplied to the second coil into a predetermined voltage, and outputs as a first divided voltage signal; and
a second voltage-dividing circuit that produces a second divided voltage signal by converting the pulsating wave into a predetermined voltage, and then generates a reference voltage by rectifying and smoothing the second divided voltage signal, and
wherein the binary circuit compares the first divided voltage signal with the reference voltage, and binarizes the first divided voltage signal.

5. The torque detection device of claim 4, wherein the waveform-shaping circuit comprises a monostable multivibrator.

6. The torque detection device of claim 1, wherein
the distortion detector unit includes a power supply circuit and a sensor unit,
the electro-magnetic coupler couples the power supply circuit with the oscillation circuit, and
the electro-magnetic coupler couples the sensor unit with the detection circuit.
